(19) United States
(12) Patent Application Publication
(10) Pub. No.: US 2020/0049124 A1
(43) Pub. Date: Feb. 13, 2020

(54) Harker oceanic power station

(71) Applicant: Matthew Wayne Harker, Lees Summit, MO (US)

(72) Inventor: Matthew Wayne Harker, Lees Summit, MO (US)

(21) Appl. No.: 15/998,367

(22) Filed: Aug. 9, 2018

(51) Int. Cl. F03B 13/22; F16H 7/06

(52) U.S. Cl. CPC F03B 13/22; F16H 7/06

(57) ABSTRACT

1. Remove original Specifications and Replace with updated version.
a. 4 deletions of underlines (one with text type change).
b. 14 changes or additions (including an “s” on “turbine” in “FIG. 2” para, 5^{th} line).
c. 1 new FIG. 3/paragraph
d. Add the claim 1—(Original).

### DESCRIPTION OF VIEWS

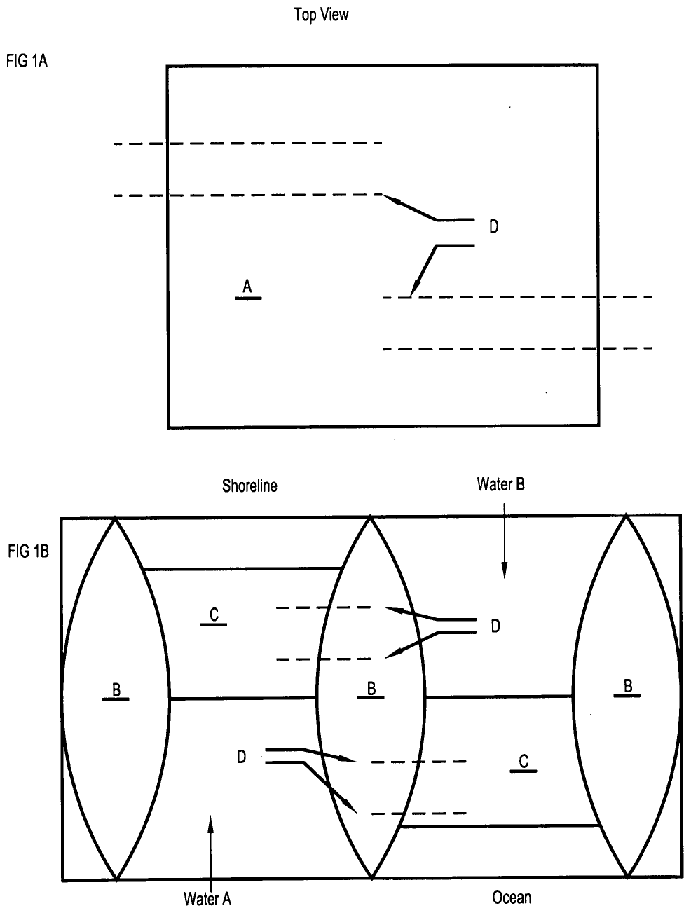

FIG. 1A

Top View-Top Half. The Harker Oceanic Power Station has two levels. The top is where the clutch/gearbox (A) is located. The clutch/gearbox (A) would be mechanically connected to a generator(s) or other device(s) for producing electricity or other services.

FIG. 1B

Top View-Bottom Half. The bottom is a pillar (B) design with turbines (C) placed alternately with the pillars. The turbines (C) and the gearbox (A) are mechanically connected by drive chains (D). The pillars (B) are shaped so that as the ocean waves pass between them, Bernoulli's Principle would speed the water's velocity up for more turbine speed. The power station can be built with varying number of turbines.

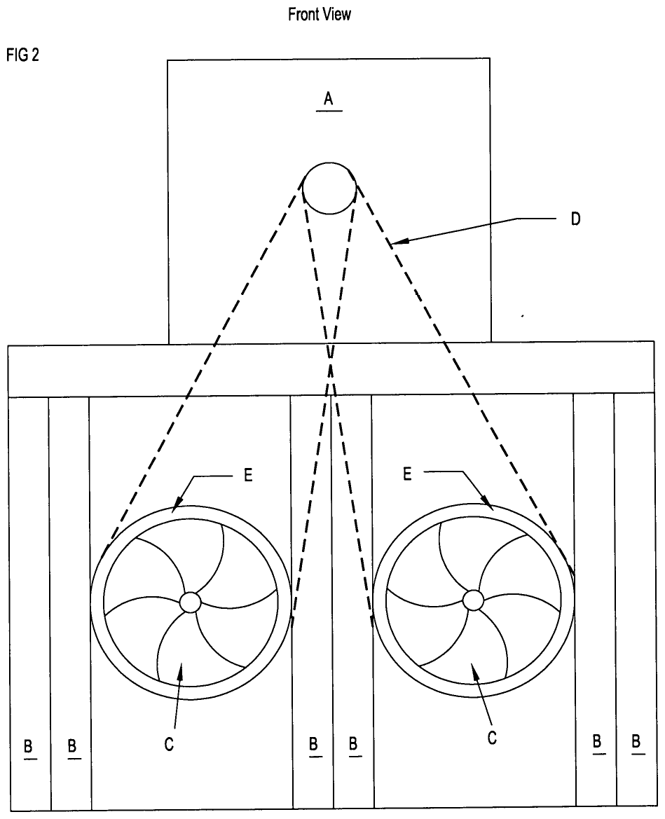

FIG. 2

Front View. The turbine (C) on one side is shaped so that ocean waves (FIG. 1B, Water A) coming in towards the shoreline turn the turbine (C) to drive the chain (D) that turns the gearbox (A). While the other turbine (C) is shaped reverse and is “freewheeling” on a ratchet (E), just like a bicycle gear does when the rider turns the pedals backwards. The ratchet (E) located on the outer edge of the turbines (C) between the turbine (C) and the chain (D). Then when the wave switches direction and the water is returning to the ocean (FIG. 1B, Water B), what was the drive turbine (C) becomes the “freewheeling” turbine (C) and what was the “freewheeling” turbine (C) becomes a drive turbine (C) turning the chain (D) that turns the gearbox (A).

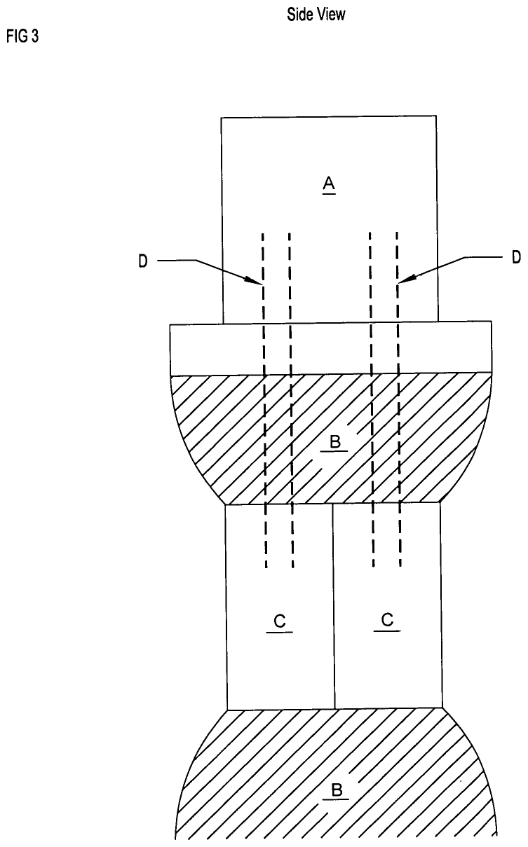

FIG. 3

Side View. Shows a cutaway view of the station. The turbines (C) are shown offset from each other, just as in FIG. 1B.

1. The ratcheted-turbines (E)-(C) are a new use of machine and process. The turbines (C) being designed for opposite drive direction and the ratchets (E) located between the turbines (C) and the drive chains (D) is what makes the idea one of a kind in the world.
